(19) United States
(12) Patent Application Publication
(10) Pub. No.: US 2011/0002581 A1
(43) Pub. Date: Jan. 6, 2011

(54) OPTICAL SWITCH AND METHOD OF MANUFACTURING THE SAME

(76) Inventor: Masatoshi Tokushima, Tokyo (JP)

Correspondence Address: Mr. Jackson Chen, 6535 N. STATE HWY 161, IRVING, TX, 75039, US

(21) Appl. No.: 12/865,770

(22) PCT Filed: Dec. 9, 2008
(86) PCT No.: PCT/JP2008/072299

§ 371 Date: Aug. 2, 2010

(30) Foreign Application Priority Data
Feb. 7, 2008 (JP) 2008-027545
Aug. 14, 2008 (JP) 2008-208927

(51) Int. Cl. G02B 6/26; G02B 6/12; B29D 11/00

(52) U.S. Cl. 385/14; 264/1.1; 385/16

(57) ABSTRACT

Provided is an optical switch that can be operated efficiently and a method of manufacturing the same. The optical switch according to the present invention is an optical switch of Mach-Zehnder interferometer type formed by a line-defect waveguide of a photonic crystal. Further, the optical switch includes a branch 7, a directional coupler 15, and waveguides 90 and 91 of two paths between them. The waveguide 90 of a first path and the waveguide 91 of a second path among the waveguides 90 and 91 of the two paths have different group velocities of guided light.

### TECHNICAL FIELD

The present invention relates to an optical switch and a method of manufacturing the same, and more specifically, to an optical switch using a waveguide and a method of manufacturing the same.

### BACKGROUND ART

There is a demand for a technology for implementing an optical integrated circuit in which optical components are integrated such as a transistor integrated circuit in which electronic components are integrated. In the current state of the art, optical components such as an optical switch, wavelength filter or a 3-dB coupler (optical coupler.) are interconnected via an optical waveguide such as an optical fiber to form an optical circuit. If these optical components could be integrated on a small chip, it would be possible to reduce the volume of the optical circuit, power consumption, and the manufacturing cost significantly.

A large variety of technologies for implementing optical integrated circuits have so far been developed. One of such technologies is a photonic crystal technology. In a broad sense of the term, a photonic crystalline or a photonic crystal is a generic name of structures the refractive index of which is caused to vary periodically. In this specification, unless otherwise mentioned, the terms “photonic crystalline” and “photonic crystal” are used synonymously.

The photonic crystals exhibit a wide variety of specific optical features, based on the periodic structure of the refractive index distribution. Their most representative feature is the photonic band gap (PBG). Normally, light can transmit through a photonic crystal. However, when periodic changes in the refractive index of a photonic crystal are sufficiently increased, the light of a particular frequency band ceases to be able to be propagated through the photonic crystal. The frequency band (or wavelength band) of the light that is able to propagate through the photonic crystal is referred to as photonic band. On the other hand, the frequency band of the light that is not able to propagate is referred to as photonic band gap (PBG), which means a gap that is between the neighboring photonic bands. A plurality of PGBs may exist in different frequency bands. The photonic band which is divided by PBG may be called a first band, a second band, and a third band, in increasing order of frequency.

If there is a small defect in the photonic crystal that might disturb periodic structure of the refractive index distribution (periodicity of the refractive index distribution) of the photonic crystal, the light at a frequency falling within the PBG is confined in the small defect. In this case, only the light at a particular frequency corresponding to the size of the defect can be confined, with the photonic crystal functioning as an optical resonator. Hence, the photonic crystal may be used as a frequency (wavelength) filter.

If small defects are arrayed within the photonic crystal in succession in a row to form a line-defect within a crystal, even the light having the frequency within the PBG can be propagated along the line-defect, while the light is confined in the line-defect. Such a photonic crystal can be used as an optical waveguide. Such an optical waveguide formed in the photonic crystal is called a line-defect waveguide.

If an optical filter and an optical waveguide can be implemented, optical functional elements such as an optical modulator or an optical switch may be constructed with one or combination of the optical waveguide and the optical filter. It is thus possible to arrange principal optical functional elements in a photonic crystal and to interconnect the optical functional elements to construct an optical circuit. Hence, the photonic crystal is expected to be used as a platform for the optical integrated circuit

If it is attempted to utilize the effect of the PBG in three perpendicular directions of x, y and z, the refractive index distribution of the photonic crystal must have three-dimensional periodic structure. However, fabrication process for a three-dimensional periodic structure is complex and hence is expensive in manufacture. For this reason, a photonic crystal having a two-dimensional periodic structure in a refractive index distribution (hereinafter may be referred to as a “two-dimensional photonic crystal”) is often used. More specifically, a two-dimensional photonic crystal of a finite size, the refractive index distribution of which having a periodicity in a substrate surface and not having a periodicity along the direction of substrate thickness, is often used. In such case, light confinement along the direction of substrate thickness is secured not by the PBG effect, but rather by total internal reflection caused by difference in the refractive index.

Strictly speaking, the characteristic of the two-dimensional photonic crystal having a finite thickness is not perfectly coincident with that of a two-dimensional photonic crystal having an infinite thickness. However, if the refractive index distribution along the direction of thickness of the two-dimensional photonic crystal having a finite thickness exhibits mirror symmetry within a region where light is propagated, the characteristic of the two-dimensional photonic crystal having a finite thickness is roughly coincident with that of the two-dimensional photonic crystal having an infinite thickness. Prediction of the operation of a device of a two-dimensional photonic crystal with infinite thickness is much easier than that for which a finite thickness is taken into account. Hence, device implementation may be facilitated by exploiting the two-dimensional photonic crystal having refractive index distribution with the mirror symmetry.

There are some examples of a concrete structure of the two-dimensional photonic crystal having a finite thickness, thus far implemented. Among them, a columnar (pillar)-type square-lattice photonic crystal has the property that the light propagation rate in a line-defect waveguide is low in a wide band, which means a low group velocity. Typically, by using a waveguide whose propagation rate is low, the optical circuit having the same function can be manufactured with small waveguide length. Therefore, the line-defect waveguide using the columnar-type square-lattice photonic crystal is suitable for the optical integrated circuit.

FIG. 8 shows a schematic diagram showing a structure of a line-defect waveguide of a columnar-type square-lattice photonic crystal with a finite thickness. In the columnar-type square-lattice photonic crystal shown in FIG. 8, circular columns 52a with a finite height and circular columns 52b having smaller diameter than the circular columns 52a, made of a high-dielectric constant material, are arrayed in a square-lattice pattern in a low dielectric constant material 1. It is called “photonic crystal” since the state that these circular columns are arranged in a square-lattice shape is similar to the state that atoms are arranged in a lattice shape in a crystal such as quartz or silicon, and it is for optical application. Therefore, the low dielectric constant material 1 and the material of the circular columns may not be crystal but may be amorphous.

In the photonic crystal shown in FIG. 8, the circular columns 52a are circular columns forming perfect photonic crystals, while circular columns 52b are smaller in diameters than the circular. columns 52a. Then, the circular columns 52b are regarded as defects introduced to the perfect crystal. In the following description, in order to differentiate the circular columns forming the perfect crystal from the circular columns corresponding to the defects, the former may be called “non-line-defect columns”, and the latter may be called “defect columns”, “defect circular columns”, or “line-defect columns”. It should be noted, however, that the line-defect columns themselves do not have defects.

The line-defect columns 52b of the photonic crystal shown in FIG. 8 are arranged in a row on a line. This row of the line-defect columns 52b and the non-line-defect columns 52a that surround the line-defect columns 52b form a line-defect waveguide. In the line-defect waveguide of the columnar-type square-lattice photonic crystal shown in FIG. 8, the row of the line-defect columns corresponds to a core in a total (internal) reflection confinement waveguide such as an optical fiber, and the lattice formed by non-line-defect columns on each side of the line-defect columns and the surrounding dielectric material correspond to a cladding. In the total (internal) reflection confinement waveguide, the waveguide does not function without the core and the cladding. In the line-defect waveguide as well, the waveguide does not function without the line-defect, and the surrounding non-line-defect columns and dielectric material.

While the optical device or the optical circuit using the columnar-type square-lattice photonic crystal is required to be reduced in size and highly integrated, no structure is developed that efficiently uses the photonic crystal in the 1×2 optical switch handled in the present invention.

One of the related 1×2 optical switches includes an optical switch using a Mach-Zehnder interferometer with a waveguide. FIG. 9 is a schematic diagram showing its configuration.

The structure and the operation of the optical switch shown in FIG. 9 is as follows.

An optical switch 72 shown in FIG. 9 is formed by a 3-dB branching waveguide 60, a 3-dB directional coupler 61, and a waveguide 62 and a waveguide 63 arranged between them. Light received by an input port 70 propagates through a waveguide 71, and is input to the 3-dB branching waveguide 60. The 3-dB branching waveguide 60 equally divides input light power. Each of the divided light propagates through the waveguide 62 and the waveguide 63, and enters two waveguides 64 and 65 that constitute the 3-dB directional coupler 61. Then, the light is emitted from output ports 66, 67 via waveguides 68 and 69. The rate of the light power emitted to the output port 66 and the output port 67 of the directional coupler varies according to the relation of the phases of the lights input to the waveguide 64 and the waveguide 65 (which and how much of the phases is advanced or delayed). By using this phenomenon, the phase difference of the light is adjusted while the light propagates through the waveguide 62 and the waveguide 63, thereby switching the exit of the light between the output port 66 and the output port 67.

The phase difference of the light while the light propagates through the waveguide 62 and the waveguide 63 is adjusted by changing the effective refractive index of one waveguide, for example, only the waveguide 63. The effective refractive index is changed by changing the refractive index of the material of the waveguide using heat or electric field.

The variation of the phase of the light that propagates through the waveguide becomes larger in proportion to the length of the waveguide. Hence, in order to facilitate the operation of the optical switch even with the slight change in the refractive index of the waveguide material, both waveguides of the waveguide 62 and the waveguide 63 may be lengthened while keeping the same length, or only the waveguide 63 whose effective refractive index is required to be changed may be lengthened.

An optical switch when the waveguides 62 and 63 have the same length may be referred to as a symmetric Mach-Zehnder 1×2 optical switch, and an optical switch when the waveguides 62 and 63 have different lengths may be referred to as a asymmetric Mach-Zehnder 1×2 optical switch.

A patent document 1 discloses a structure of a 1×2 optical switch which is reduced in size using a photonic crystal.

According to the reference numerals of FIG. 2 of the patent document 1, a two-dimensional photonic crystal slab (31) includes a waveguide (20) which is a branching waveguide. Further, the two-dimensional photonic crystal slab (31) includes an “interference channel” (35) and a “resonant member” (37).

### [Patent Document 1]

Japanese Unexamined Patent Application Publication No. 2003-161971

### DISCLOSURE OF INVENTION

### Technical Problem

In the 1×2 optical switch using the typical waveguide shown in FIG. 9, when the waveguide is lengthened in order to facilitate the operation of the optical switch even with the slight change in the refractive index of the waveguide material, power of control signals such as electricity or light to change the refractive index of the waveguide needs to be increased.

Increase in the whole length of the optical switch may decrease the operation speed of the optical switch accordingly.

On the other hand, in the 1×2 optical switch using the photonic crystal disclosed in the patent document 1, there is a problem that frequency that can be applied is limited to around the frequency that causes resonance by the “resonant member”.

The present invention has been made in view of the background as above, and aims to provide an optical switch that can be operated efficiently and a method of manufacturing the same.

### Technical Solution

An optical switch according to the present invention is an optical switch of Mach-Zehnder interferometer type formed by a line-defect waveguide of a photonic crystal, the optical switch including a branch, a directional coupler, and waveguides of two paths between the branch and the directional coupler, in which the waveguide of a first path of the two paths and the waveguide of a second path of the two paths have different group velocities of guided light.

Further, an optical switch according to the present invention is an optical switch of Mach-Zehnder interferometer type formed by a line-defect waveguide of a pillar-type photonic crystal, the optical switch including a branch, a directional coupler, and waveguides of two paths between the branch and the directional coupler, in which the cross-sectional areas of defect pillars that form a line-defect of a waveguide of at least one path of the two paths are smaller than the cross-sectional areas of defect pillars that form a line-defect of waveguides that form the branch and the directional coupler.

Further, an optical switch according to the present invention is an optical switch of Mach-Zehnder interferometer type formed by a line-defect waveguide of a photonic crystal, the optical switch including a branch, a directional coupler, and waveguides of two paths between the branch and the directional coupler, in which at least a part or all of the waveguide of at least one path of the two paths operates as a resonator that resonates for light having frequencies other than a waveguide band of a waveguide forming the directional coupler.

Furthermore, a method of manufacturing an optical switch according to the present invention is a method of manufacturing an optical switch of Mach-Zehnder interferometer type formed by a line-defect waveguide of a photonic crystal, the method including forming a branch, a directional coupler, and waveguides of two paths between the branch and the directional coupler, in which the waveguide of a first path and the waveguide of a second path among the two paths have different group velocities of guided light.

### Advantageous Effects

The present invention may provide an optical switch that may be efficiently operated and a method of manufacturing the same.

### BRIEF DESCRIPTION OF DRAWINGS

FIG. 1 is a schematic cross sectional view of an optical switch according to a first exemplary embodiment;

FIG. 2 shows a transmission spectrum of a structure of the optical switch shown in FIG. 1;

FIG. 3 shows an electromagnetic field distribution of light when the light is output from one output port of the optical switch shown in FIG. 1;

FIG. 4 shows an electromagnetic field distribution of light when the light is output from the other output port of the optical switch shown in FIG. 1;

FIG. 5 is a schematic cross sectional view of a photonic crystalline including a refractive index tuner according to the first exemplary embodiment;

FIG. 6 is a schematic cross sectional view showing a structure of an optical switch according to a second exemplary embodiment;

FIG. 7 shows a schematic cross sectional view showing a structure of the optical switch including an input part of control light according to the second exemplary embodiment;

FIG. 8 is a stereographic view of a square-lattice pillar-type photonic crystal including a line-defect; and

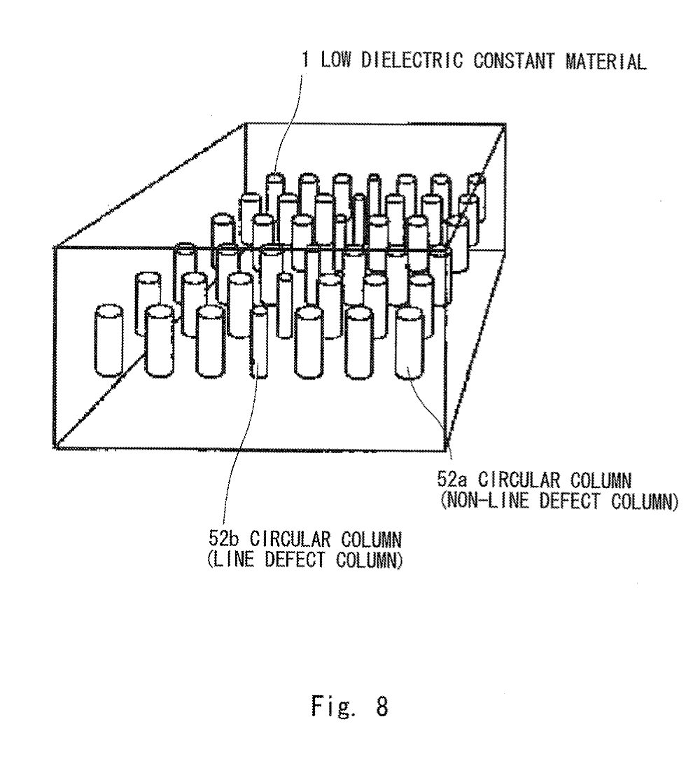

FIG. 9 is a schematic diagram of a 1×2 optical switch shown by waveguides.

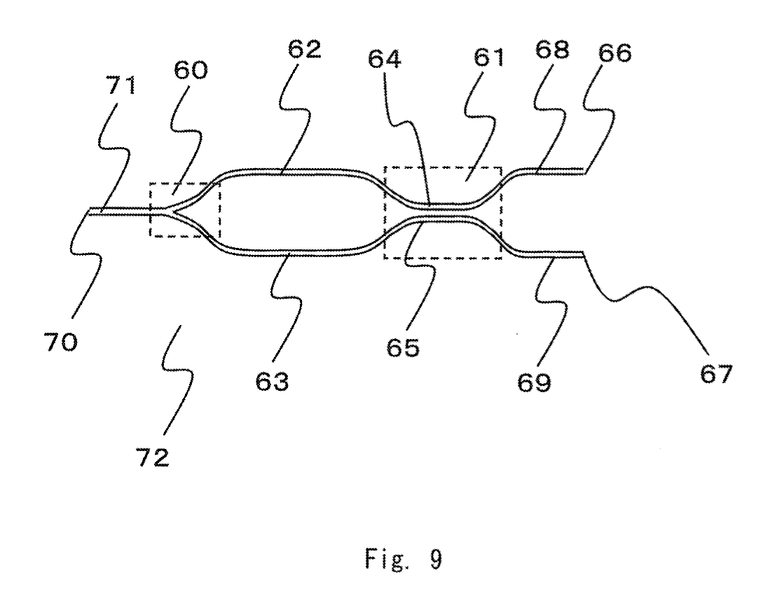

### EXPLANATION OF REFERENCE

7 BRANCH

8 WAVEGUIDE OF THE FIRST PATH

9 LINE-DEFECT PILLARS

10 WAVEGUIDE OF THE SECOND PATH

11 CONNECTION WAVEGUIDE

12 LINE-DEFECT PILLARS

13 TAPERED WAVEGUIDES

14 TAPERED WAVEGUIDES

15 DIRECTIONAL COUPLER

16 LINE-DEFECT PILLARS

17 LINE-DEFECT PILLARS

18 LINE-DEFECT PILLARS

19 OUTPUT END

20 OUTPUT END

21 LINE-DEFECT PILLARS

22 LINE-DEFECT PILLARS

23 LINE-DEFECT PILLARS

80 HEATER

90 WAVEGUIDE OF THE FIRST PATH

91 WAVEGUIDE OF THE SECOND PATH

100 TAPERED WAVEGUIDES

101 LINE-DEFECTECT PILLARS

102 TAPERED WAVEGUIDES

103 LINE-DEFECT PILLARS

104 TAPERED WAVEGUIDES

105 LINE-DEFECT PILLARS

106 TAPERED WAVEGUIDES

107 LINE-DEFECT PILLARS

110 CONNECTION WAVEGUIDE

111 LINE-DEFECT PILLARS

112 CONNECTION WAVEGUIDE

113 LINE-DEFECT PILLARS

120 ADJACENT WAVEGUIDE

121 LINE-DEFECT PILLARS

122 ADJACENT WAVEGUIDE

123 LINE-DEFECT PILLARS

### BEST MODE FOR CARRYING OUT THE INVENTION

### First Exemplary Embodiment

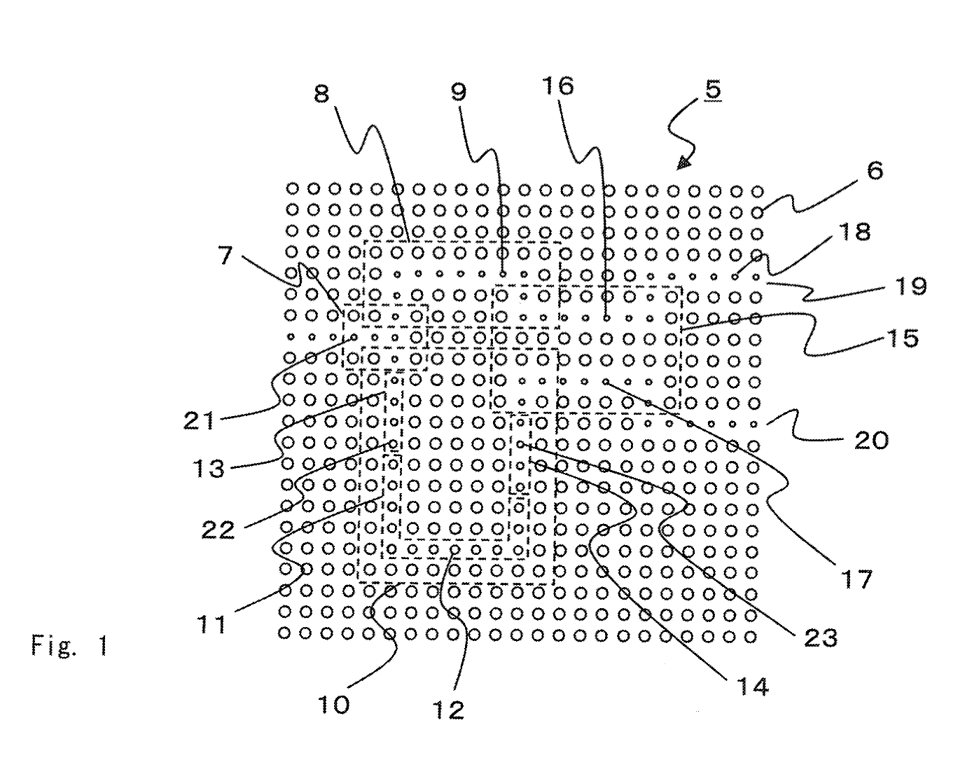

An optical switch according to a first exemplary embodiment of the present invention will be described in detail with reference to the drawings. The optical switch according to the first exemplary embodiment is, for example, an m×n optical switch (m is an integer of one or more, and n is an integer of two or more) using a Mach-Zehnder interferometer and including m input ports (input ends) and n output ports (output ends). Note that the Mach-Zehnder interferometers include an asymmetric Mach-Zehnder interferometer and/or a symmetric Mach-Zehnder interferometer. First, with reference to FIG. 1, a 1×2 optical switch of asymmetric Mach-Zehnder interferometer type will be described as one example of the optical switch according to the first exemplary embodiment. In short, a 1×2 optical switch that includes one input end and two output ends will be described. FIG. 1 is a schematic diagram showing a structure of a 1×2 optical switch 5 according to the first exemplary embodiment.

The 1×2 optical switch 5 according to the first exemplary embodiment is, in many cases, included as a part of any pillar (columnar)-type square-lattice photonic crystal. A periodic lattice of the photonic crystal is a lattice of dielectric columns of the high refractive index arranged in a medium having relatively low refractive index. In summary, the 1×2 optical switch 5 is an optical switch of asymmetric Mach-Zehnder interferometer type formed of a line-defect waveguide of a photonic crystal.

The 1×2 optical switch 5 according to the first exemplary embodiment includes a branch 7 and a directional coupler 15. The branch 7 is a T branch, where a line-defect waveguide is provided in a T shape. The branch 7 equally divides light power received by one input end and emits light power from two output ends. The directional coupler 15 includes two waveguides that are adjacent to each other, and connects and branches light power received by two input ends to emit the light power from two output ends, for example.

Further, the 1×2 optical switch 5 includes a waveguide 8 of a first path and a waveguide 10 of a second path between the branch 7 and the directional coupler 15. Among these two paths, the waveguide 8 of the first path and the waveguide 10 of the second path have different group velocities of guided light. In the first exemplary embodiment, as one example, the group velocities of the guided light are made different by making cross-sectional areas of the line-defect pillars of the waveguides 8 and 10 of the paths different from each other. The line-defect pillars mean defect pillars that form a line-defect. Specifically, the cross-sectional areas of the line-defect pillars 12, 22, and 23 of the waveguide 10 of the second path are larger than the cross-sectional areas of line-defect pillars 9 of the waveguide 8 of the first path. Further, the waveguide length of the second path is larger than the waveguide length of the first path.

Further, tapered waveguides 13 and 14 are provided in either end of the waveguide 10 of the second path. A connection waveguide 11 is provided between the two tapered waveguides 13 and 14. In summary, the connection waveguide 11 is connected to the waveguide of the branch 7 through the tapered waveguide 13. Further, the connection waveguide 11 is connected to the waveguide of the directional coupler 15 through the tapered waveguide 14. The cross-sectional areas of the line-defect pillars 22 and 23 of the tapered waveguides 13 and 14 are gradually increased or decreased from one end toward the other end. Specifically, the cross-sectional areas of the line-defect pillars 22 and 23 of the tapered waveguides 13 and 14 are gradually decreased with increasing distance from the connection waveguide 11. Further, the cross-sectional areas of line-defect pillars 16 and 17 of the two waveguides that form the directional coupler 15 are the same for the both waveguides.

The operating principle is as follows.

In the 1×2 optical switch 5 of the present invention, the waveguide 10 of the second path has larger group velocity dispersion. The waveguide having larger group velocity dispersion produces larger phase shift even with a slight change in the refractive index. The waveguide according to the first exemplary embodiment may produce a phase shift which is several to tens of times larger than the change rate of the refractive index. As a result, output of light can be switched between an output end 19 and an output end 20 even with the change in the refractive index in the order of 0.1% of the waveguide 10 of the second path.

In summary, the exit of the light can be switched with the change in the refractive index of about a tenth of those of relevant 1×2 optical switches. Hence, the operation of the 1×2 optical switch 5 can be made simpler without increasing the waveguide length of the 1×2 optical switch 5. Accordingly, it is possible to suppress power of a control signal such as electricity or light to change the refractive index of a waveguide. In summary, the optical switch can effectively be operated with a power of the control signal. Therefore, low-power operation is possible, thereby achieving energy saving. Further, operation speed of the 1×2 optical switch 5 can be improved. Since there is no need to increase the waveguide length, the 1×2 optical switch 5 can be reduced in size. Further, the optical switch can be embedded in the photonic crystal optical integrated circuit, thereby achieving a highly-integrated optical switch circuit. According to the first exemplary embodiment, the optical switch can be effectively operated using the novel feature of the photonic crystal waveguide.

Since only the waveguide 10 of the second path has large group velocity dispersion, light that propagates through other waveguide areas is hardly influenced by group velocity dispersion. This means that, even when a high-speed light signal transmits through the optical switch of the present invention, this light signal is hardly distorted. Therefore, the performance of the 1×2 optical switch 5 is hardly degraded.

Next, an outline of a method of manufacturing the photonic crystalline of this example will be described. The photonic crystalline of this example may be manufactured using an SOI wafer (Silicon On Insulator Wafer) as a substrate. As an SOI wafer, a buried oxide film having a thickness of 2.0 μm and a silicon active layer having a thickness of 1.0 μm are used. The silicon active layer is a non-doped one.

First, a pattern as shown in FIG. 1 is drawn using an electron beam direct writing technique. When the wavelength of the guided light is set to 1.55 μm for optical communication, the lattice constant is set to 0.4 μm and the diameter of non-line-defect pillars 6 is set to 0.24 μm. The diameter of the line-defect pillars is 0.16 μm in the waveguide area. The waveguide area here means the area other than the stub waveguide, i.e., the area other than the waveguide 10 of the second path. In short, the diameter of the line-defect pillars 9, 16, 17, 18, 21 is 0.16 μm. The diameter is gradually increased to 0.22 μm in a departing direction away from the connection point with a waveguide in the stub waveguide area. The length of the waveguide stub is set to 15 μm.

Next, by anisotropic dry etching, the silicon active layer is vertically manufactured in accordance with the resist pattern that is drawn.

After that, the remaining resist pattern is removed by acetone. Last, an ultraviolet-curing resin having the refractive index of 1.45 is applied, which is the same as that of the buried oxide film, and the resin is cured with ultraviolet rays for completion.

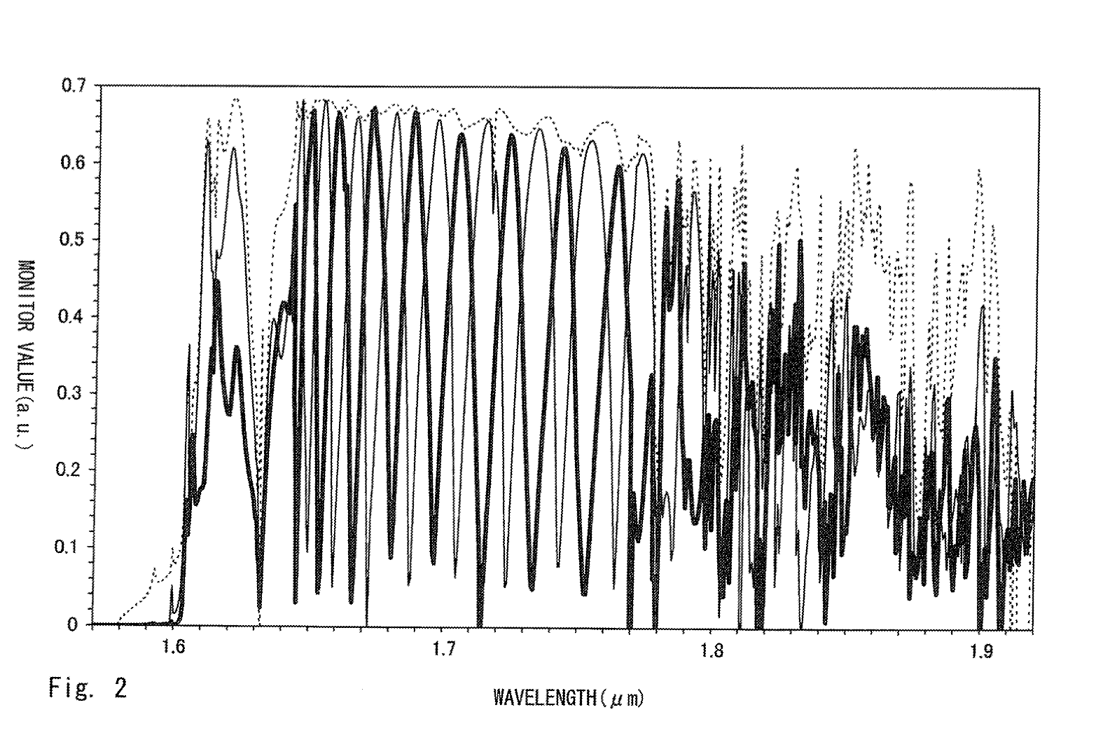

The transmission spectrum shown in FIG. 2 is a calculation result when it is assumed that the pillars of the silicon is infinite in the thickness direction in the above structure, for the sake of simplicity.

In FIG. 2, thick curves and thin curves that are greatly oscillating according to wavelengths represent output intensities of light output from the two output ends 19 and 20. Light is output alternately for a wide frequency range. Applying heat or electrical field to the 1×2 optical switch 5 shifts these curves in a long wavelength side or a short wavelength side concurrently due to the change in the refractive index. Hence, for light of a certain wavelength, the output ends 19 and 20 are switched due to the change of the refractive index. Since there is produced oscillation of the output light intensity in a light wavelength range, the 1×2 optical switch 5 can be used for a wide wavelength range. In short, the operating frequency of the 1×2 optical switch 5 is not limited.

Note that a dashed line at the top in the wide wavelength range in FIG. 2 shows light intensity of input light.

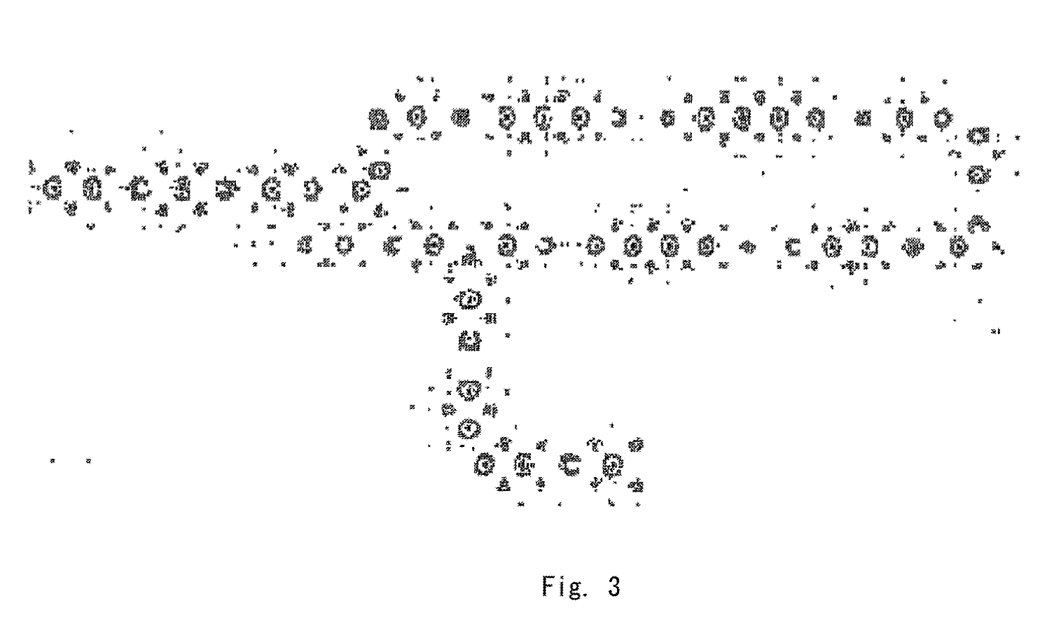

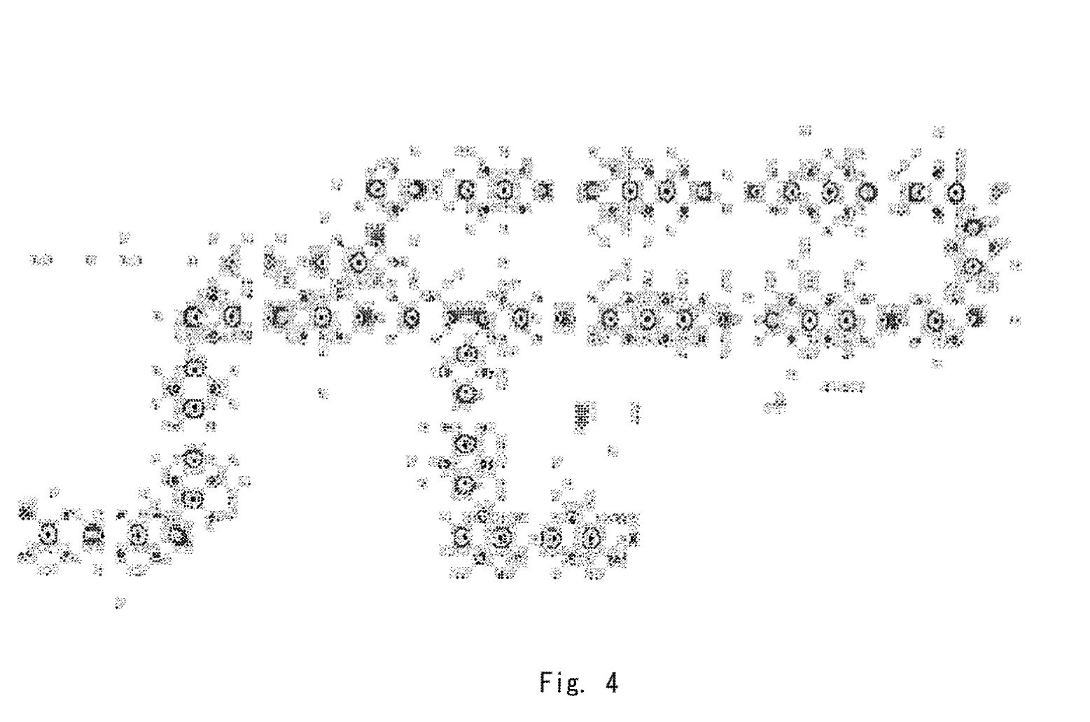

FIGS. 3 and 4 each show a calculation result of electrical field distribution of the optical switch when light outputs from different output ports.

Described above is one example of the photonic crystalline according to the first exemplary embodiment of the present invention. However, the present invention is not limited to the first exemplary embodiment described above. For example, circular columns other than the line-defect pillars that form a photonic crystalline may be displaced, or the cross-sectional area thereof may be increased or decreased. Although the non-line-defect pillars 6 and the line-defect pillars 9, 12, 16, 17, 18, 21, 22, and 23 are circular columns in the first exemplary embodiment, they are not limited to it. They may have other shapes such as quadrangular columns or octagonal columns.

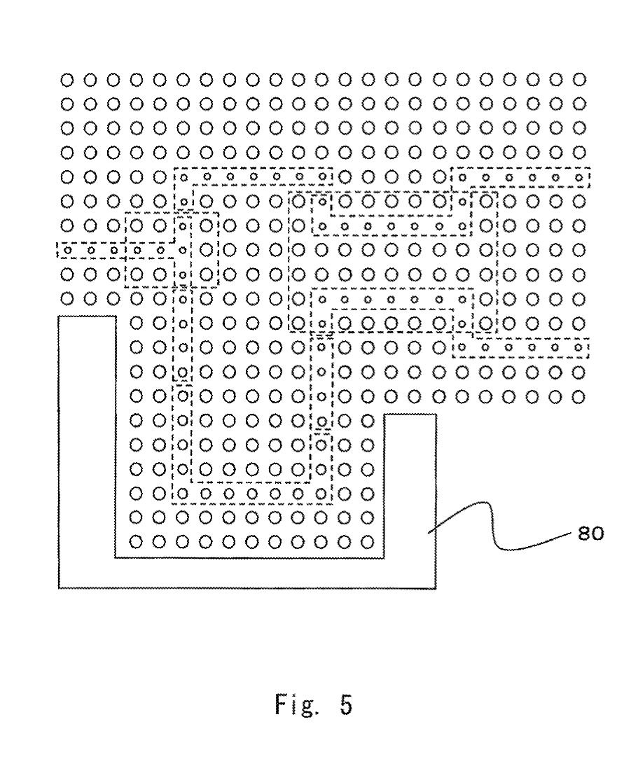

FIG. 5 shows an optical switch on which a heater 80 is mounted as a temperature regulator to cause changes in the refractive index. When the heater 80 is warmed up, the refractive index of the waveguide 10 of the second path varies, and the transmission spectrum of the photonic crystalline is shifted in the long wavelength side or the short wavelength side. As a result, the transmission factor of the light varies in a certain wavelength, and the optical switch operates as the 1×2 optical switch 5.

The same operation is performed also when a tuner to change the refractive index is an electrical field intensity regulator or a current regulator.

### Second Exemplary Embodiment

Now, an optical switch according to a second exemplary embodiment will be described.

The first exemplary embodiment provides a 1×2 optical switch that is capable of switching output ends of light efficiently even when waveguides of two paths between the branch and the directional coupler are short. The second exemplary embodiment described below provides a structure that is especially effective in varying the refractive index of the path between the branch and the directional coupler by input of control light. In the second exemplary embodiment, at least one of the waveguides of the two paths between the branch and the directional coupler includes a resonator, and tuning of the refractive index of the path that is selected is performed with the light which is resonated by the resonator.

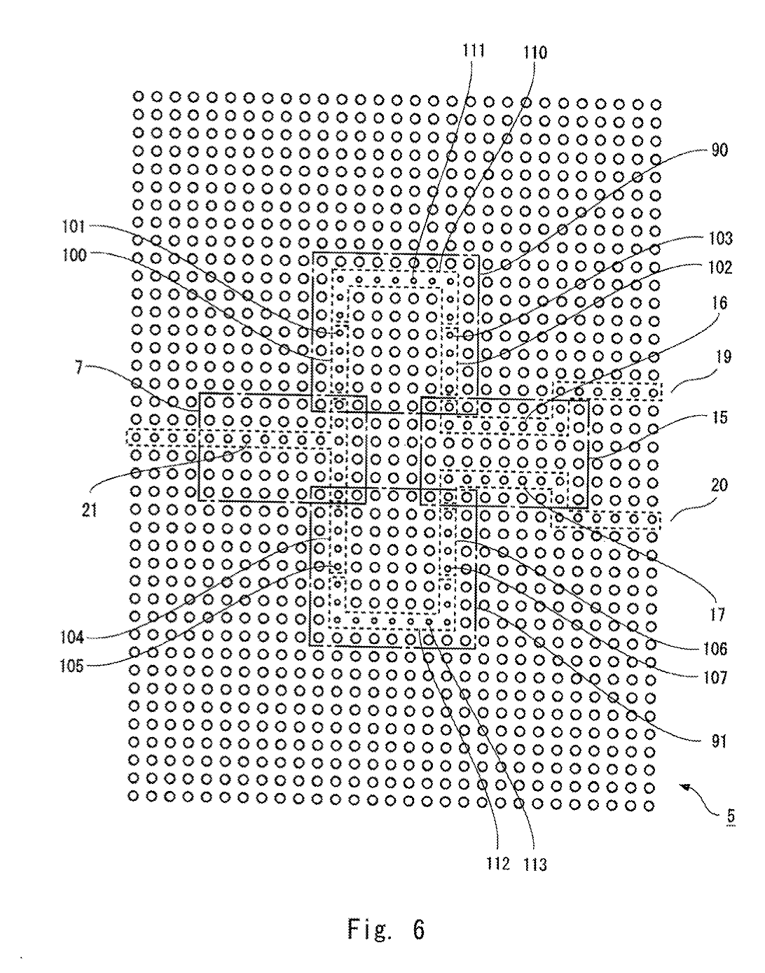

Referring to FIG. 6, the structure of the optical switch according to the second exemplary embodiment will be described. As one example, a 1×2 optical switch will be described as one example of the optical switch. FIG. 6 is a schematic diagram showing the structure of the 1×2 optical switch 5 according to the second exemplary embodiment. Description that is common to the first exemplary embodiment is omitted or simplified.

The 1×2 optical switch 5 shown in FIG. 6 is included as a part of any pillar (columnar)-type square-lattice photonic crystal. The 1×2 optical switch 5 includes a branch 7, a directional coupler 15, and waveguides 90 and 91 of two paths between the branch 7 and the directional coupler 15. The 1×2 optical switch 5 forms a Mach-Zehnder interferometer. More specifically, as is similar to the first exemplary embodiment, the branch 7 is arranged in an input side of the 1×2 optical switch 5, and the directional coupler 15 is arranged in an output side of the 1×2 optical switch 5. The branch 7 and the directional coupler 15 are connected by the waveguide 90 of the first path and the waveguide 91 of the second path.

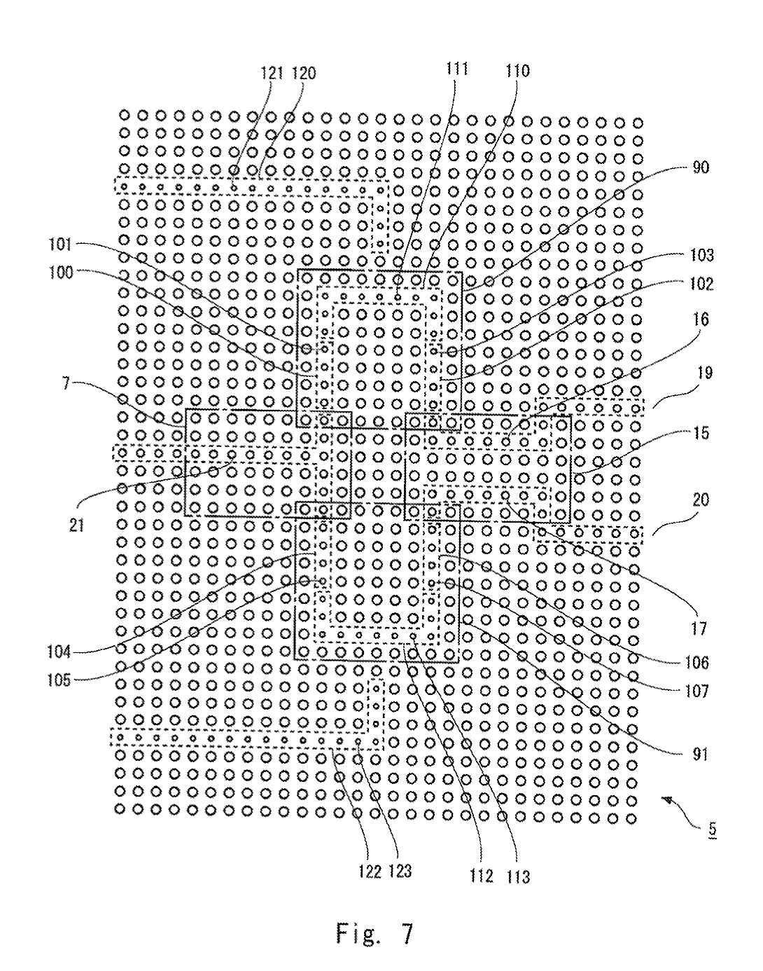

Among the two paths, the cross-sectional areas of the defect pillars that form the line-defect of the waveguide of at least one path are smaller than the cross-sectional areas of the defect pillars that form the line-defect of the waveguide that forms the branch 7 and the directional coupler 15. In FIG. 6, the cross-sectional areas of line-defect pillars 101, 103, and 111 of the waveguide 90 of the first path are smaller than the cross-sectional areas of line-defect pillars 16 and 21 of the waveguide that forms the branch 7 and the directional coupler 15. Similarly, the cross-sectional areas of line-defect pillars 105, 107, and 113 of the waveguide 91 of the second path are smaller than the cross-sectional areas of line-defect pillars 17 and 21 of the waveguide that forms the branch 7 and the directional coupler 15. For the sake of simplicity, in the following description, the line-defect of the waveguide, i.e., the area, in which the line-defect pillars are aligned, may be simply referred to as a waveguide. Further, the line-defect of the waveguide denoted by the reference symbol 100 and so on in FIGS. 6 and 7 may be simply referred to as a waveguide in this specification.

The waveguide of the path having smaller cross-sectional area of the defect pillars includes two tapered waveguides that are arranged at different ends. The 1×2 optical switch 5 further includes a connection waveguide that is arranged between the two tapered waveguides and connected to the branch 7 and the directional coupler 15 through these tapered waveguides. Specifically, the waveguide 90 of the first path includes two tapered waveguides 100 and 102, and a connection waveguide 110 provided between the two tapered waveguides 100 and 102. Further, the waveguide 91 of the second path includes two tapered waveguides 104 and 106, and a connection waveguide 112 provided between the two tapered waveguides 104 and 106.

In the waveguide 90 of the first path, the cross-sectional areas of the line-defect pillars 101 and 103 of the photonic crystal waveguide that forms the tapered waveguides 100 and 102 are gradually increased with increasing distance from the connection waveguide 110. Similarly, in the waveguide 91 of the second path, the cross-sectional areas of the line-defect pillars 105 and 107 of the photonic crystal waveguide that forms the tapered waveguides 104 and 106 are gradually increased with increasing distance from the connection waveguide 112. The cross-sectional areas of the line-defect pillars of the tapered waveguide are smaller than the cross-sectional areas of the line-defect pillars of the directional coupler 15 or the branch 7 connected to one end, and are larger than the cross-sectional areas of the line-defect pillars of the connection waveguide connected to the other end.

As stated above, the cross-sectional areas of the line-defect pillars 101, 103, 105, and 107 are smoothly changed in the tapered waveguides 100, 102, 104, and 106. Thus, light that transmits through the waveguide does not sense abrupt change in the shape of the waveguide; hence, unnecessary reflection does not occur. The 1×2 optical switch 5 according to the second exemplary embodiment is formed as above.

As stated above, the cross-sectional areas of the line-defect pillars 111 and 113 of the connection waveguides 110 and 112 are smaller than the cross-sectional areas of the line-defect pillars 16, 17, and 21 of the branch 7 and the directional coupler 15. Hence, the connection waveguides 110 and 112 are able to guide light having a frequency higher than the upper limit of the transmission band of the branch 7 and the directional coupler 15. Now, the frequency of the upper limit of the transmission band of the branch 7 and the directional coupler 15 is denoted by f1, and the frequency of the upper limit of the transmission band of the connection waveguides 110 and 112 is denoted by f2. In this case, by adjusting the lengths of the connection waveguides 110 and 112 appropriately, light having a frequency between f1 and f2, e.g., frequency of f3, causes resonance in the areas of the connection waveguides 110 and 112.

As stated above, the connection waveguides 110 and 112 function as resonators. Therefore, the 1×2 optical switch 5 according to the second exemplary embodiment can also be described as follows. A part or all of the waveguides of at least one path of the waveguides 90 and 91 of the two paths between the branch 7 and the directional coupler 15 operates as a resonator. Further, this resonator resonates against the light having a frequency other than the waveguide bands of the waveguides that form the branch 7 and the directional coupler 15.

More specifically, light that causes the resonance has a frequency higher than the upper limit of the transmission bands of the branch 7 and the directional coupler 15. Thus, the light that causes the resonance cannot transmit through the waveguides that form the branch 7 and the directional coupler 15, and thus the light does not leak through the branch 7 and the directional coupler 15. Thus, stable operation of the 1×2 optical switch 5 can be achieved.

Since light having high intensity exists in the resonator, there is a strong third-order non-linear effect in the connection waveguides 110 and 112. Hence, the refractive indices of the connection waveguides 110 and 112 are significantly changed. Otherwise, when the connection waveguides 110 and 112 absorb even a small amount of light, a part of the energy of the light having high intensity stored in the connection waveguides 110 and 112 is absorbed and changed to heat. Then, since the connection waveguides 110 and 112 are heated up, the refractive index varies by the thermo-optic effect. Thus, the refractive indices of the connection waveguides 110 and 112 can be modulated.

Connecting the control light and the guided light selectively changes the refractive indices of the connection waveguides 110 and 112. Then, the transmission properties of the connection waveguides 110 and 112 can be shifted in a short wavelength side or a long wavelength side. Light that is equal to or lower than the frequency f1 can transmit through the directional coupler 15, and can be switched by the 1×2 optical switch 5. Thus, according to the second exemplary embodiment, the optical switch that can be controlled with light can be effectively operated.

When using the 1×2 optical switch 5 according to the second exemplary embodiment, the guided light of the connection waveguides 110 and 112 has higher group velocity compared with the guided light of the branch 7 or the directional coupler 15. Thus, unlike the first exemplary embodiment, the effect of reducing the waveguides 90 and 91 of the two paths cannot be employed. However, the refractive indices of the connection waveguides 110 and 112 can be effectively varied by control light having the frequency f3. Then, the optical switch according to the second exemplary embodiment can be operated as the optical switch that can be controlled with light.

Referring next to FIG. 7, the 1×2 optical switch including the input part of the control light will be described. FIG. 7 is a schematic diagram showing a structure of the 1×2 optical switch 5 including the input part of the control light according to the second exemplary embodiment. The structures other than the input part of the control light are similar to those of the 1×2 optical switch 5 shown in FIG. 6.

An adjacent waveguide 120 is arranged near the connection waveguide 110. Similarly, an adjacent waveguide 122 is arranged near the connection waveguide 112. Line-defect pillars 121 and 123 of the adjacent waveguides 120 and 122 each have cross-sectional areas equal to or smaller than those of the line-defect pillars 111 and 113 of the neighboring connection waveguide 110 or connection waveguide 112. The connection waveguide 110 and the adjacent waveguide 120, and the connection waveguide 112 and the adjacent waveguide 122 are optically coupled to each other. The adjacent waveguides 120 and 122 each have L shape so that they are folded by about 90° in the side of the neighboring connection waveguide 110 or connection waveguide 112, for example. Hence, the adjacent waveguides 120 and 122 can be made adjacent to the connection waveguide 110 or the connection waveguide 112 effectively. The adjacent waveguides 120 and 122 are input parts of the control light, and function as controlling waveguides.

In other words, the controlling waveguides are each arranged near the resonators. The controlling waveguides are able to guide light having frequency in a bandgap of the photonic crystal. Further, the controlling waveguides are able to guide the light having the resonance frequency of each resonator of the two connection waveguides 110 and 112. Each resonator and each controlling waveguide are optically coupled.

By making the controlling waveguides or the adjacent waveguides 120 and 122 appropriately apart from the connection waveguides 110 and 112, Q value can be made sufficiently large. Now, the Q value is the value that indicates an intensity at which the resonator confines light. In short, the intensity of the light stored in the connection waveguides 110 and 112 may be set to Q times of the light having the frequency f3 guided through the adjacent waveguides 120 and 122. The Q value can be set between several thousands and several tens of thousands. Thus, when the light having the frequency f3 of small intensity is received, the light energy of high intensity is stored in the connection waveguides 110 and 112. Then, as stated above, the refractive index can be efficiently changed. Accordingly, the optical switch that can be controlled with light can be operated.

The light guided through the branch 7 or the directional coupler 15 enters the connection waveguides 110 and 112. However, since there are tapered waveguides 100, 102, 104, and 106 between them, no reflection occurs due to the abrupt change in the structure of the waveguides. Thus, light having the frequency of f1 or less does not cause resonance in the process of transmitting through the 1×2 optical switch 5. Therefore, the intensity of the light having the frequency of f1 or less in the connection waveguides 110 and 112 is substantially the same to the intensity when the light passes through the branch 7 or the directional coupler 15. Thus, the intensity of leaked light having the frequency of f1 or less from the connection waveguide 110 to the adjacent waveguide 120, and from the connection waveguide 112 to the adjacent waveguide 122 is no more than 1/Q of the intensity of the light that transmits through the connection waveguide 110 or the connection waveguide 112, which is negligible.

Note that, in the tapered waveguides 100, 102, 104, and 106, the cross-sectional areas of the dielectric columns that form the defects of the line-defect may be increased in a step-like pattern in a direction that is away from the connection waveguides 110 and 112. Specifically, in the tapered a departing direction away from the connection waveguides 100, 102, 104, and 106, the cross-sectional areas of the line-defect pillars 101, 103, 105, and 107 may be increased in a step-like pattern in a departing direction away from the connection waveguides 110 and 112. Further, the tapered waveguides 100, 102, 104, and 106 may have a region that is gradually decreased in cross-sectional areas of the line-defect pillars and a region that is increased in a step-like pattern.

The waveguides 90 and 91 of the two paths between the branch 7 and the directional coupler 15 may have the same length or different lengths. Hence, a symmetric Mach-Zehnder interferometer may be formed by making the length of the waveguides 90 and 91 of the two paths the same, or an asymmetric Mach-Zehnder interferometer may be formed by making the lengths of the waveguides 90 and 91 of the two paths different.

When the 1×2 optical switch 5 is a symmetric Mach-Zehnder interferometer, the adjacent waveguides 120 and 122 are made adjacent to the both connection waveguides 110 and 112 as shown in FIG. 7, for example. In this case, when the control light is input to only one of the two adjacent waveguides 120 and 122, the output ends 19 and 20 of the light are switched. Then, the 1×2 optical switch 5 may perform the operation of the logic circuit so that the output ends 19 and 20 of the light are not switched when no control light is input to both of the adjacent wavelengths 120 and 122 or the control light is input to both of them.

Further, when the 1×2 optical switch 5 is an asymmetric Mach-Zehnder interferometer, as described above, the adjacent waveguides 120 and 122 are made adjacent to the both connection waveguides 110 and 112. Hence, the 1×2 optical switch 5 may perform the operation of the logic circuit that is different from the case in which the symmetric interferometer is used. Further, they may be combined.

Although the photonic crystal is a square-lattice pillar-type photonic crystal in FIGS. 6 and 7, it may be a triangle-lattice hole-type photonic crystal. Naturally, the same thing applies to the first exemplary embodiment as well. Two or more of such 1×2 optical switches 5 may be arranged, and adjacent waveguides (controlling waveguides) 120 and 122 included in each 1×2 optical switch 5 may be the same or may be connected to each other.

Needless to say, the present invention is not limited to the exemplary embodiments described above, but various changes can be made without departing from the spirit of the present invention already described above.

This application claims the benefit of priority, and incorporates herein by reference in its entirety, the following Japanese Patent Application No. 2008-27545 filed on Feb. 7, 2008 and Japanese Patent Application No. 2008-208927, filed on Aug. 14, 2008.

### INDUSTRIAL APPLICABILITY

The present invention is applicable to an optical switch and a method of manufacturing the same, and more specifically, to an optical switch using a waveguide and a method of manufacturing the same.

1. An optical switch of Mach-Zehnder interferometer type formed by a line-defect waveguide of a photonic crystal, the optical switch comprising:
a branch;
a directional coupler; and
waveguides of two paths between the branch and the directional coupler,
wherein the waveguide of a first path of the two paths and the waveguide of a second path of the two paths have different group velocities of guided light.

2. The optical switch according to claim 1, the waveguide of the second path has larger cross-sectional area of defect pillars that form a line-defect than the waveguide of the first path.

3. The optical switch according to claim 2, wherein the length of the waveguide of the second path is larger than the length of the waveguide of the first path.

4. The optical switch according to claim 2, wherein both waveguides have the same cross-sectional areas of defect pillars that form a line-defect of two waveguides forming the directional coupler.

5. The optical switch according to claim 2, wherein the waveguide of the second path includes:
two tapered waveguides that are arranged in different ends; and
a connection waveguide provided between the two tapered waveguides, the connection waveguide being connected to the branch and the directional coupler through the tapered waveguides.

6. The optical switch according to claim 5, wherein the cross-sectional areas of defect pillars of photonic crystal waveguides that form the two tapered waveguides are gradually decreased with increasing distance from the connection waveguide.

7. An optical switch of Mach-Zehnder interferometer type formed by a line-defect waveguide of a pillar-type photonic crystal, the optical switch comprising:
a branch;
a directional coupler; and
waveguides of two paths between the branch and the directional coupler,
wherein the cross-sectional areas of defect pillars that form a line-defect of a waveguide of at least one path of the two paths are smaller than the cross-sectional areas of defect pillars that form a line-defect of waveguides that form the branch and the directional coupler.

8. The optical switch according to claim 7, wherein the waveguide of the path having the smaller cross-sectional area of the defect pillars comprises:
two tapered waveguides that are arranged in different ends; and
a connection waveguide that is arranged between the two tapered waveguides and is connected to the branch and the directional coupler through the tapered waveguides.

9. The optical switch according to claim 8, wherein the cross-sectional areas of defect pillars of photonic crystal waveguides that form the two tapered waveguides are gradually increased with increasing distance from the connection waveguide.

10. The optical switch according to claim 8, wherein the optical switch includes an adjacent waveguide having defect pillars having cross-sectional areas equal to or smaller than the cross-sectional areas of the defect pillars forming the line-defect of the connection waveguide near the connection waveguide, and the connection waveguide and the adjacent waveguide are optically connected.

11. An optical switch that comprises two or more of the optical switch according to claim 10,
wherein the adjacent waveguide included in each optical switch is the same or connected to each other.

12. An optical switch of Mach-Zehnder interferometer type formed by a line-defect waveguide of a photonic crystal, the optical switch comprising:
a branch;
a directional coupler; and
waveguides of two paths between the branch and the directional coupler,
wherein at least a part or all of the waveguide of at least one path of the two paths operates as a resonator that resonates for light having frequencies other than a waveguide band of a waveguide forming the directional coupler.

13. The optical switch according to claim 12, comprising a controlling waveguide near the resonator, the controlling waveguide being capable of guiding light having a frequency in a bandgap of the photonic crystal and capable of guiding light having a resonance frequency of the resonator,
wherein the resonator and the controlling waveguide are optically connected.

14. An optical switch comprising two or more of the optical switch according to claim 13,
wherein the controlling waveguide included in each optical switch is the same or connected to each other.

15. A method of manufacturing an optical switch of Mach-Zehnder interferometer type formed by a line-defect waveguide of a photonic crystal, the method comprising:
forming a branch, a directional coupler, and waveguides of two paths between the branch and the directional coupler,
wherein the waveguide of a first path and the waveguide of a second path among the two paths have different group velocities of guided light.

16. The optical switch according to claim 3, wherein both waveguides have the same cross-sectional areas of defect pillars that form a line-defect of two waveguides forming the directional coupler.

17. The optical switch according to claim 3, wherein the waveguide of the second path includes:
two tapered waveguides that are arranged in different ends; and
a connection waveguide provided between the two tapered waveguides, the connection waveguide being connected to the branch and the directional coupler through the tapered waveguides.

18. The optical switch according to claim 4, wherein the waveguide of the second path includes:
two tapered waveguides that are arranged in different ends; and
a connection waveguide provided between the two tapered waveguides, the connection waveguide being connected to the branch and the directional coupler through the tapered waveguides.

19. The optical switch according to claim 9, wherein the optical switch includes an adjacent waveguide having defect pillars having cross-sectional areas equal to or smaller than the cross-sectional areas of the defect pillars forming the line-defect of the connection waveguide near the connection waveguide, and the connection waveguide and the adjacent waveguide are optically connected.
